(19) United States
(12) Patent Application Publication
(10) Pub. No.: US 2013/0166378 A1
(43) Pub. Date: Jun. 27, 2013

(54) METHOD AND APPARATUS FOR OPTIMIZING CONTENT TARGETING

(71) Applicant: Federated Media Publishing, LLC, San Jose, CA (US)

(72) Inventors: Tim Musgrove, Morgan Hill, CA (US); Robin Walsh, San Francisco, CA (US); James Hull, San Jose, CA (US); Peter Ridge, San Jose, CA (US)

(73) Assignee: FEDERATED MEDIA PUBLISHING, LLC, San Jose, CA (US)

(21) Appl. No.: 13/725,474

(22) Filed: Dec. 21, 2012

Related U.S. Application Data
(60) Provisional application No. 61/578,860, filed on Dec. 21, 2011.

(51) Int. Cl. G06Q 30/02

(52) U.S. Cl. CPC G06Q 30/0251
USPC 705/14.49

(57) ABSTRACT

Methods and apparatus for optimizing content targeting with optimal topics. An exemplary method comprises determining metadata characteristics associated with topics of interest, determining an inventory of the metadata characteristics, determining performance characteristics associated with the metadata characteristics; and determining optimal topics associated with the metadata characteristics. The metadata characteristics preferably include primary metadata characteristics and ancillary metadata characteristics associated with the primary metadata characteristics, and determining the optimal topics is preferably based at least in part on the inventory of the metadata characteristics and the performance characteristics of the metadata characteristics.

### RELATED APPLICATION DATA

This application claims priority to U.S. Provisional Application 61/578,860, filed Dec. 21, 2011, which is hereby incorporated by reference in its entirety.

### FIELD OF THE INVENTION

The present disclosure in general relates to optimizing content targeting with optimal topics.

### BACKGROUND OF THE INVENTION

There are many computer systems today allowing marketers or their representatives to specify types of web content against which their marketing programs should be targeted. This defining of the target area is accomplished up front, before an online campaign begins, chiefly by specifying keywords, tags, or topics in advance.

In many cases this is a guess-and-test process, wherein the human agent involved does not immediately know (a) how much inventory is available (e.g. how many web pages there are) bearing a certain keyword or topic, nor (b) how well an ad will perform when attached to a particular topic (e.g. what it's click-through rate or “CTR” will be). Thus a barrier, or at least a bottleneck, is created by this guess-and-test predicament. Ad platforms that operate at a low price-point (for example, as of this writing, web display ads priced at less than $4 per thousand impressions, or $4 CPM or lower), cannot reasonably be scaled while requiring human creation and iteration of topics or keywords. And even on higher CPM platforms, the human cost of defining keyword clusters or topic trees or whatever related information structure is to define the ad targeting, imposes a delay in time and an increase in cost that is highly undesirable.

### SUMMARY OF THE INVENTION

The disclosed embodiment relates to methods and apparatus for optimizing content targeting with optimal topics. An exemplary method comprises determining metadata characteristics associated with topics of interest, determining an inventory of the metadata characteristics, determining performance characteristics associated with the metadata characteristics; and determining optimal topics associated with the metadata characteristics. The metadata characteristics preferably include primary metadata characteristics and ancillary metadata characteristics associated with the primary metadata characteristics, and determining the optimal topics is preferably based at least in part on the inventory of the metadata characteristics and the performance characteristics of the metadata characteristics.

The metadata characteristics can be associated with, for example, a topic, a keyword, a title, a named entity, an abstract, and the like. In addition, determining the inventory of the metadata characteristics can be based on a predetermined inventory threshold. Furthermore, the performance thresholds can be associated with, for example, click-through-rate, mouse-over rate, survey response rate, and the like, and determining the performance characteristics can be based on, for example, current performance characteristics and historical performance characteristics associated with the metadata characteristics.

The ancillary metadata characteristics can be identified by the primary metadata characteristics as being associated with the primary metadata characteristics, and, similarly, the primary metadata characteristics can be identified by the ancillary metadata characteristics as being associated with the ancillary metadata characteristics. In addition to the primary metadata characteristics and ancillary metadata characteristics, the metadata characteristics can further include second-order metadata characteristics associated with the ancillary metadata characteristics, and even further include third-order metadata characteristics related to the second-order metadata characteristics. Metadata characteristics associated with any of the topics can also be determined through topic-tag cloud expansion.

The apparatus of the disclosed embodiment preferably comprises one or more processors, and one or more memories operatively coupled to at least one of the one or more processor. The memories have instructions stored thereon that, when executed by at least one of the one or more processors, cause at least one of the one or more processors to carry out the disclosed methods.

The disclosed embodiment further relates to non-transitory computer-readable media storing computer-readable instructions that, when executed by one or more computing devices, cause at least one of the one or more computing devices to carry out the disclosed methods.

### BRIEF DESCRIPTION OF THE DRAWINGS

These and other features, aspects, and advantages of the present disclosure will be better understood when the following detailed description is read with reference to the accompanying drawings in which like characters represent like parts throughout the drawings, wherein:

FIG. 1 illustrates an exemplary method according to the disclosed embodiment.

FIG. 2 shows a diagram illustrating exemplary metadata characteristics according to the disclosed embodiment.

FIG. 3 illustrates exemplary relationships between primary metadata characteristics, ancillary metadata characteristics, second-order metadata characteristics, and third-order metadata characteristics according to the disclosed embodiment.

FIG. 4 illustrates a real world example of relationships between primary metadata characteristics, ancillary metadata characteristics, second-order metadata characteristics, and third-order metadata characteristics according to the disclosed embodiment.

FIG. 5 shows a diagram illustrating exemplary factors contributing to the determination of optimal topics according to the disclosed embodiment.

FIG. 6 illustrates exemplary documents with initial sets of associated tags and topics according to the disclosed embodiment.

FIG. 7 illustrates an exemplary topic-tag cloud with generated associations according to the disclosed embodiment.

FIG. 8 illustrates an exemplary computer system according to the disclosed embodiment.

### DETAILED DESCRIPTION OF THE INVENTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings. While the invention described herein is provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof

The disclosed embodiment relates to a system and method for automatically generate optimal sets of metadata to support relevant content targeting for ads, with sufficient inventory, with the highest likelihood of satisfactory click-through and without requiring human attention.

To accomplish this, the disclosed embodiment considers three factors: metadata characteristics (i.e. topical relevance), an available inventory, and performance characteristics, such as click-through-rate, or CTR. To balance these factors, the disclosed methods preferably assume that a substantially large ad network is available that may, with respect to certain topics, have limited inventory, that the metadata characteristics (i.e. content metadata, including, for example, keywords, topics, summary statements, or the like) are available for most pages on the network, and that historical CTR's are largely available for pages on the network.

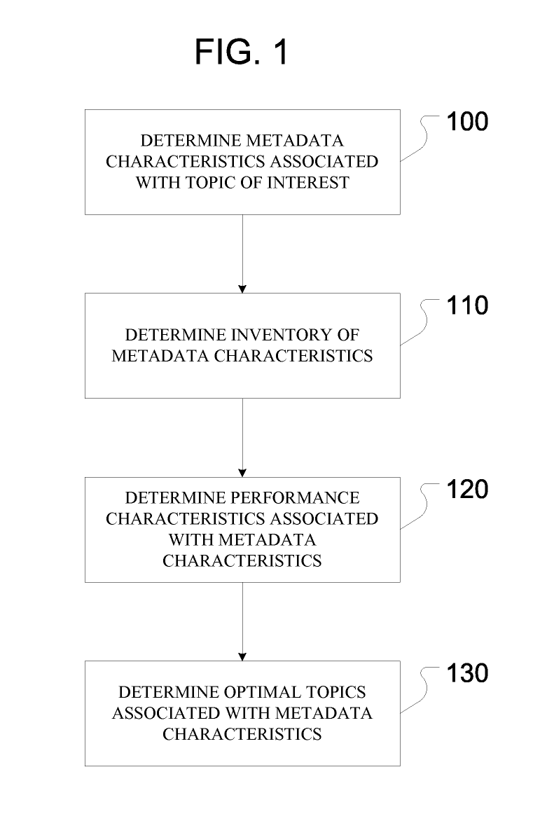

As shown in FIG. 1, an exemplary method according to the disclosed embodiment includes determining one or more metadata characteristics associated with one or more topics of interest, in step 100, determining an inventory of the metadata characteristics, in step 110, determining performance characteristics associated with the metadata characteristics, in step 120, and determining one or more optimal topics associated with the metadata characteristics, in step 130.

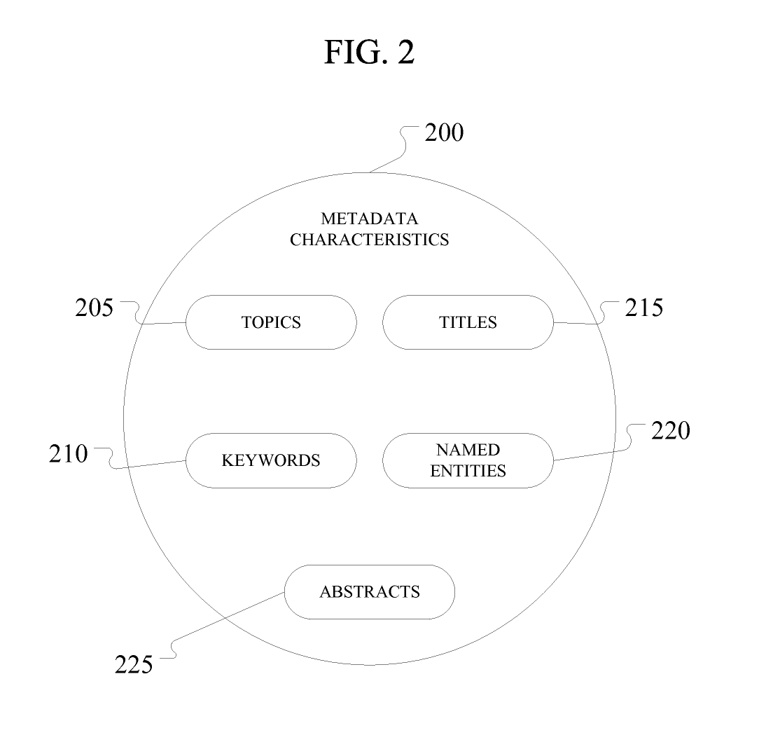

As shown in FIG. 2 and described herein, metadata characteristics 200 can include a wide-variety of factors including, for example, topics 205, keywords 210 (i.e. associated with the topics), titles 215 (i.e. of documents or other content), named entities 2 20 (i.e. authors, publishers, editors, developers, contributors, etc.), abstracts 220 (i.e. summaries of the topic), and the like. In addition, the metadata characteristics preferably include primary metadata characteristics and ancillary metadata characteristics, described in more detail below.

After one or more topics (having metadata characteristics) are identified for targeting, a determination can be made to identify related topics. It is possible that actually a collection of several (perhaps dozens) of related topics, out of a list numbering many thousands, may be selected by the end of the process. This is because it is the nature of most topics to have many related topics, which may be ancillary, supplemental, or subordinate topics. It is preferable to include such related topics in order to achieve sufficient inventory for advertising purposes.

Typically, related topic sets are sparse and greatly under-specify the full range of topics that ideally, and truly, are potentially related, either to themselves or to a specific document. This usually results from one of two causes. Either an automated system was used to determine related topics, and in order to achieve high accuracy, the system must be conservative in setting very high confidence thresholds, resulting in just a handful of related topics; or a human editorial process was used, either by experts (the authors themselves or expert editors), or by outsourced contractors who are not experts. In the case of experts, they are notoriously lazy when it comes to tagging content with topics at all, and even more lazy when asked to relate all their topics to each other. In the case of outsourced non-experts, their lack of expertise results in very few related topic links being made, compared to the number that should be.

To overcome the typical sparseness in related topic links, the disclosed embodiment identifies not only metadata characteristics associated with the chosen topics (referred to herein as “primary metadata characteristics”), but also metadata characteristics associated with ancillary topics identified through topic links and/or tags corresponding to the chosen topics (referred to herein as “ancillary metadata characteristics”). This process can be repeated even further to identify metadata characteristics associated with second-order topics identified through topic links and/or tags corresponding to the ancillary topics (referred to herein as “second-order metadata characteristics”), to identify metadata characteristics associated with third-order topics identified through topic links and/or tags corresponding to the second-order topics (referred to herein as “third-order metadata characteristics”), etc. This process can continue until the desired number of topics are identified.

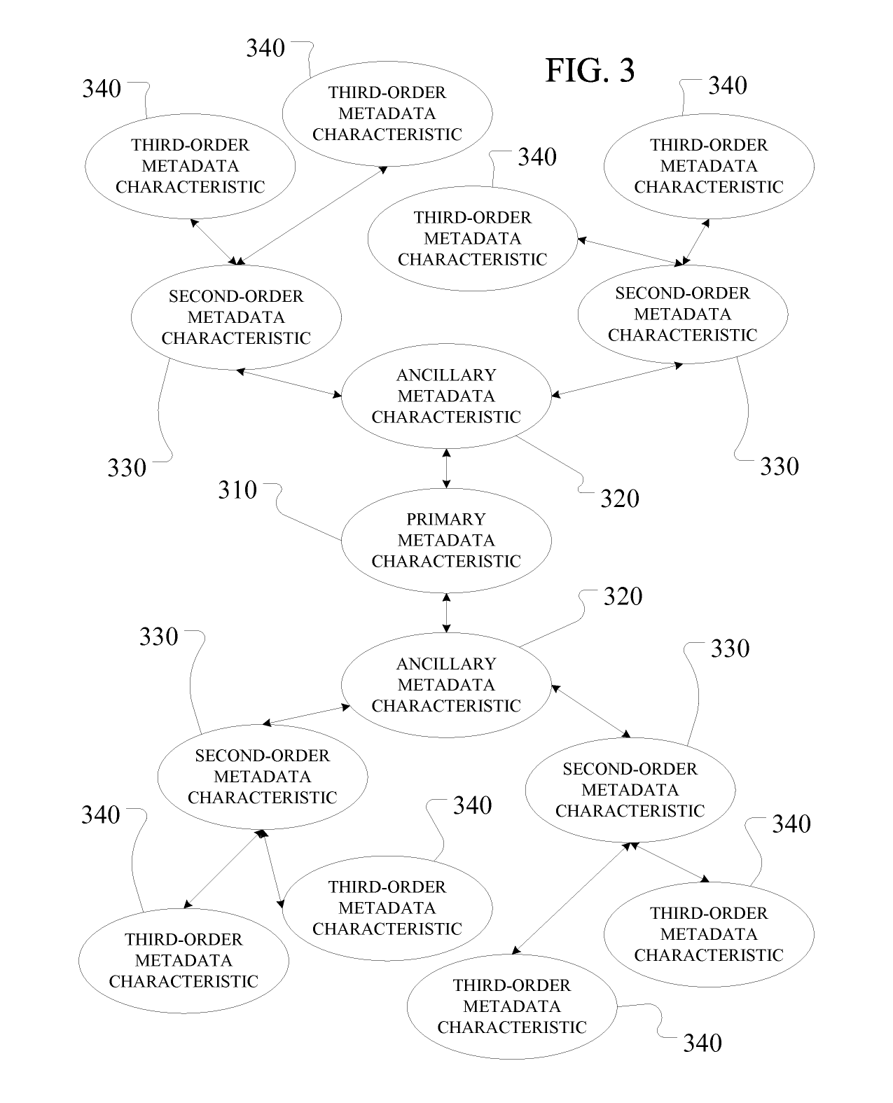

FIG. 3 shows a generic diagram of the relationships between primary metadata characteristics 310, ancillary metadata characteristics 320, second-order metadata characteristics 330, and third-order metadata characteristics 340. As is shown in FIG. 3, primary metadata characteristic 310 is directly related to two ancillary metadata characteristics 320, but is not directly related to second-order metadata characteristics 320 or third-order metadata characteristics 330. Ancillary metadata characteristics 320 are directly related to both primary metadata characteristic 310 and also second-order metadata characteristics 330, but not to third-order metadata characteristics 330. Second-order metadata characteristics 330 are directly related to both ancillary metadata characteristics 320 and third-order metadata characteristics 340, but not to primary metadata characteristics 310. Third-order metadata characteristics 340 are directly related to second-order metadata characteristics 330, but not ancillary metadata characteristics 320 or primary metadata characteristics 310. Of course, if desired, there could be even more metadata characteristics include fourth-order, fifth-order, etc. if desired.

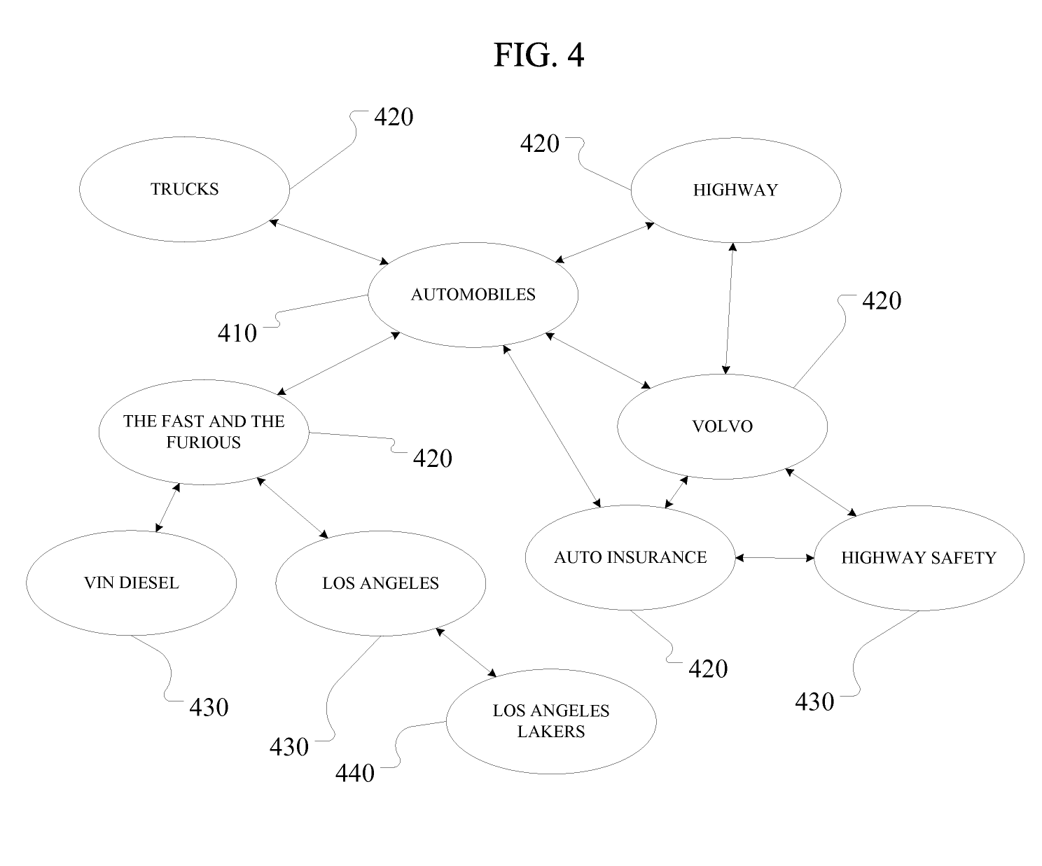

One exemplary technique to identify these related topics is a “topic tag cloud expansion”, which is described later in this document. These related topics may also be identified by traversing through the links within the semantic network of existing related topics, as in the following real world example, which is illustrated in FIG. 4.

As shown in FIG. 4, the primary metadata characteristics are associated with primary topic Automobiles 410. In this example, primary topic Automobiles 410 is related to ancillary topics Highway, Trucks, Volvo, Auto Insurance, and “The Fast and the Furious” (all labeled 420). However, topic Highway Safety 430 is not an ancillary topic to Automobiles 410, but is instead related to Volvo 420 and Auto Insurance 420. In this example, it simply did not occur to human editors to make this connection, nor did it arise out of any automated system that might have been used to create the related topic links. However, it would clearly be incorrect to think that Highway Safety 430 is not related to Automobiles 410. Thus, by considering second-order metadata characteristics through second-order topics in the semantic network, Highway Safety 430 can be determined to be related to Automobiles 410 as a second-order topic having second-order metadata characteristics.

However, if all second-order topics are considered to be related to the primary topic, some topics will be identified that are clearly not desirable. For example, primary topic Automobiles 410 is also related to “The Fast and The Furious” 420, which is a movie about illegal street racing of automobiles. By following the semantic network shown in FIG. 4, “The Fast and the Furious” 420 is also related to topic Los Angeles 430, which is where the movie is set. Thus, through “The Fast and the Furious” 420, Los Angeles 430 is a second-order topic relative to primary topic Automobiles 410, and is associated with second-order metadata characteristics. Including second-order metadata characteristics associated with Los Angeles 430 with primary metadata characteristics associated with Automobile 410 is clearly not desirable. Imagine an ad campaign intended to target web pages that are about automobiles, now targeting also every web page that is related to “Los Angeles.” Thus, it is preferable to filter second-order and further metadata characteristics to ensure one relevant metadata characteristics are utilized.

To validate second-order metadata characteristics and second-order topics, the systems and methods of the disclosed embodiment determine whether the identified second-order topics themselves reference any other ancillary topics that reference back to the primary topic. As shown in FIG. 4, Los Angeles 430 does not have any additional related or ancillary topics that connect back to Automobiles 410, besides the one already considered, “The Fast and the Furious” 420. Thus, the second-order topic Los Angeles 430, and its associated second-order metadata characteristics, can be disregarded. Similarly, third-order topic Los Angeles Lakers 440, which is an ancillary topic to Los Angeles 430, should also be disregarded.

However, Highway Safety 430 has many additional ancillary topics that point directly back to Automobiles 410, such as Auto Insurance 420 and Volvo 420. Thus, second-order topic

Highway Safety 430, and its second-order metadata characteristics, should be included. By setting a threshold that requires a reasonable plurality of such connections, various second-order related topics, and their associated metadata characteristics, can be identified and utilized, as appropriate. This results in a successful, relevant, and largely “noise-free” expansion of the original topic set of primary and ancillary topics. It should be understood that, for clarity, this example has been greatly over-simplified. In actuality there would be many dozens more related topics that would need to be examined for a topic as broad as Automobiles 410.

After identifying the topics and metadata characteristics that should be included, the inventory characteristics (i.e. web traffic numbers) for each topic and their associated metadata characteristic can be determined. Preferably, a determination of inventory for a topic or its associated metadata characteristics includes an analysis of all URLs in a given network corresponding to the topic. This analysis can include any network, from a single local network operated on one or more computing machines to a large corporate network to the entire internet, if desired. By analyzing one or more networks for the identified topics and their associated metadata characteristics, the methods and systems of the disclosed embodiment can determine which topics have a sufficient inventory, and thus, should be included in the optimization process.

In addition to the inventory determination, it is also preferable to consider performance characteristics for the identified topics and their associated metadata characteristics. Performance characteristics can include usage information including, for example, CTR's. Performance characteristics can be determined relative to the performance of the identified topics and their associated metadata characteristics for each URL's parent domain (e.g. the website or blog on which it was published) and those for the identified topics and their associated metadata characteristics across all URL's. Utilizing both dimensions of performance characteristics eliminates inaccuracies that can be encountered when the performance characteristics of many smaller websites or blogs, which may make up a significant portion of the determined inventory, are assumed to reflect the performance characteristics of the identified topics and their associated metadata characteristics across all relevant networks. Performance characteristics of the identified topics and their associated metadata characteristics on smaller networks may not be consistent with performance characteristics of the identified topics and their associated metadata characteristics on larger websites which may have traditionally dominated the same topics in the past.

For example, suppose that today a story about leaking batteries in cell phones “goes viral” on a number of blogs, and the topic of “cell phones” is targeted according to the disclosed embodiment. While it could be that the topic “cell phones” has an overall performance CTR of just 0.04 percent, owing to mainstream media treatment of the topic, the fact that the topic is trending with independent bloggers may result in a substantial inflation or spike in web traffic, for example, an average CTR of 0.11 percent. If the determination of performance characteristics of the topic and its associated metadata characteristics was based solely on the independent bloggers today, the results would be overly inflated. Similarly, if the determination of performance characteristics of the topic and its associated metadata characteristics was based solely on the historical performance for independent bloggers or on the overall historical or current performance, the results would likely be under-estimated.

Thus, according to the disclosed embodiment, one technique for determining performance characteristics is based on, for example, the performance characteristics of the topic and its associated metadata characteristics today relative to a specific range of networks (i.e. a “domain footprint”) as well as the historical performance characteristics of the topic and its associated metadata characteristics over the same specific range of networks. This technique ensures that short-term fluctuations will not overly distort the performance characteristic determination.

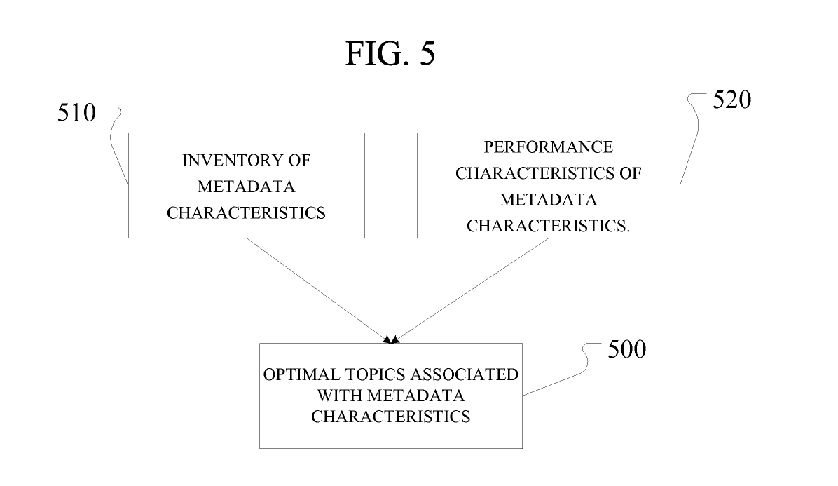

After the metadata characteristics associated with the topics of interest, the inventory of the metadata characteristics, and the performance characteristics associated with the metadata characteristics have been determined or otherwise obtained, the methods and systems of the disclosed embodiment enable a determination of optimal topics associated with identified topics or their associated metadata characteristics. As shown in FIG. 5, the determination of optimal topics 500 is preferably based at least in part on the inventory 510 and the performance characteristics 520 described above.

More specifically, the optimal topics are preferably determined by weighting the relevance of all identified topics, the inventory associated with them, and the performance characteristics.

These considerations can include, as described above, the historical CTR for URL's under each identified topic in their respective parent domains, thus, determining a set of related topics that are optimal—those that create enough inventory, with a likely high enough CTR, while still related to the main topic or topics.

There are many parameters to assembling this final set of optimal topics correctly. For example, there may be a minimum required inventory availability or minimum threshold for performance characteristics such as CTR. There may also be a variety of flexibility with how the related topics (ancillary, second-order, third-order, etc.) are determined, for example, based on preferences of the customer, such as a marketer. (“Do you want to target only the iPhone 4GS exactly, or any iPhone, or any topic related to the iPhone, or even to any and all smart phones?”) Based on these constraints, and their ranked priority against each other, the disclosed methods and systems can automatically produce an adequate set of topics, if possible, or alternatively, can show the closest-matching set of topics. Optionally, a human editor may review and make any desired adjustments before approving or rejecting the proposed targeting program.

In addition to making the baseline determination of optimal topics described above, the disclosed methods and systems can also be utilized to update the set of optimal topics by re-executing the methods while the ad campaign is actually running, when the actual performance characteristics and actual inventory characteristics are known and available. For example, if the pacing of the inventory fulfillment is slow, then a broader assortment of related topics could be added to increase the grasp of inventory. Conversely, if the campaign is over-pacing, a tighter set of topics with even greater relevance and/or higher CTR's can be used. Alternatively, if the CTR's are running too low, then under-performing topics can be dropped and others with stronger CTR or stronger topic relevance can be retained, if this will not reduce inventory below the minimum needed. In other words, by following the same procedure mid-campaign, the disclosed embodiment enables campaign performance optimization.

It should be understood that other content metadata characterizations could be substituted for “topics” herein. For example, metadata characterizations can include, for example, keywords, title words, named entities, abstracts, etc. Also performance characteristics can include any ad campaign performance metric, including, for example, response rates to surveys, mouse-over's on “engagement ads”, or any other metric that counts user reaction to ads or to ad-like materials. Indeed “ads” could be replaced with other forms of targeted marketing literatures, such as sponsored blog posts, surveys, polls, videos, etc. In all cases, some form of inter-related topical metadata, along with inventory data and some form of user-action measurement, are all that is required for the system to be fully implemented.

### EXAMPLE

### Topic Tag Cloud Expansion

This section describes an alternative embodiment of utilizing topics and related topics or tags that are assigned broadly across a sizable text corpus, in order to derive second-order topic assignments for many documents within that corpus, thereby overcoming the topic-sparseness problem discussed earlier. It is assumed in this example that documents can be described and indexed by means of various metadata and that one type of such metadata is a tag, which consists of a word or phrase. For example, “bat”, “ball” and “grand slam” could be tags that describe a document about the sport of baseball. Tags are non-hierarchical and are typically represented in clusters called tag clouds. Due to the lack of relationships between tags and the granular nature of many tags, broader and more organized forms of metadata are desirable to organize documents and determine relationships between them.

Therefore, after establishing a set of tags for a document, it is useful to then infer general topics of discourse within the document by utilizing generally-known and dynamically-constructed associations of tags to topics, also known as tag-to-topic relationships. For example, the tags “homerun”, “bat” and “grand slam” might be associated with the topic of “Baseball”. The set of topics within a collection of documents provides a more abstract and manageable set of labels, useful for such applications as information retrieval, ad targeting, etc. In addition, these topics can be organized into hierarchies to provide taxonomical structure to a corpus of documents.

One limitation in assigning topics to a document naturally becomes the extent to which topics may be gleaned from a basic set of tags based on a particular knowledgebase, especially if that document's tag set is sparse. To augment the tag-to-topic relations in the knowledgebase and to subsequently enhance topic assignments, a topic-tag cloud is derived from existing tag-to-topic relationships over available corpora.

A topic-tag cloud is a set of all tags that are associated with all documents that are assigned to a topic, along with relevance scores. Thus, a topic-tag cloud is much more “fuzzy” than the explicit tag-to-topic relations that are used to assign a document to a topic based on its tags. Whereas explicit tag-to-topic relationships have a very strong implication that when a tag applies to a document, so does the topic, the strength of topic-tag relationships to a topic can vary significantly due to the indirect method used to derive the relationship. After the topic-tag cloud is generated, it is then used during a second processing operation that assigns topics to a document.

The concept of using a topic-tag cloud was created in order to augment the assignment of topics to documents. One possible embodiment of the invention is for use in ad targeting. The topics are assigned to documents by way of tag-to-topic associations as derived from a knowledgebase. This can be seen as discovery by automated means of a plurality of ancillary, supplemental, or subordinate topics—sets of topics which are combined into more conceptually generalized meta-topics, so that these meta-topics may then be offered, for example, to advertisers to target their ads against, with the expectation of improving the contextual relevance of the ad to the contents of the article, blog post or web page while increasing the “reach” of the ad campaign (covering more inventory of web pages). Two limitations of this mechanism became apparent, one being the creation and evolution of the meta-topic associations, the second being the occasional lack of topics being generated for some documents. To minimize the number of documents in a corpus with few or no topics and thereby improve the topic coverage, the concept of a topic-tag cloud was conceived as an a priori tag-to-topic relationship as derived from existing corpora where tags and topics had already been assigned via previous methods. Documents could then be processed by this secondary “topic expansion” method in order to increase the likelihood of generating topic assignments at all, and furthermore that these topics would be present in the meta-topic groupings.

It is presumed in this example that there exists a method of identifying basic tags for a document (i.e., relevant proper names, noun phrases, etc.), as well as a basic method for associating these tags with higher-level topics by way of tag-to-topic relations within a knowledgebase (i.e., taxonomical mappings, hand-crafted mappings, machine-generated relationships, etc.). It is also presumed that these methods have been employed over a significant number of documents within one or more corpora.

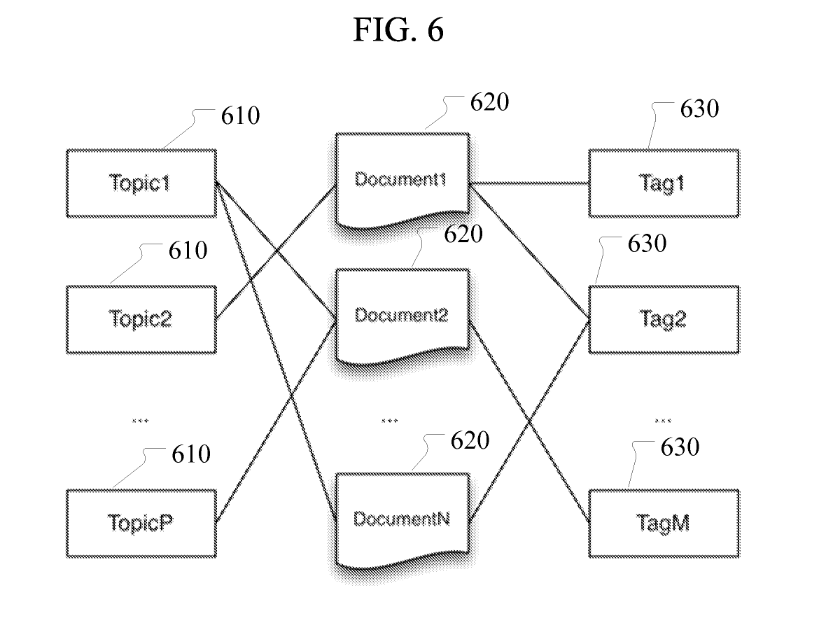

The process uses all documents within a given set of corpora in the following exemplary method illustrated in FIG. 6. First, select all topic associations 610 for all documents 620 in order to compile a full set of topics, TS. For each topic T in TS, select all documents D associated with the topic T. It is preferable not to consider topics that were derived exclusively from the use of a previously generated topic-tag cloud in order to prevent erroneous inferences from such a feedback loop.

For each document d in set D, select all tags t (630 in FIG. 6) that were assigned. Aggregate tags across all documents, deriving a score Sₜ for each distinct tag using the relevance scores that the tag has to each document, S_{t,d}, in the following manner:

$${S}_{t} = {S}_{{t}_{n}} where {S}_{{t}_{o}} = 0 , \\ {S}_{{t}_{i}} = {S}_{{t}_{i - 1}} + ( 1 - {S}_{{t}_{i - 1}} ) \cdot ( {S}_{t , {d}_{i}} \cdot \frac{n}{N} ) \cdot C , i = 1 , 2 , … , n$$

where n is the number of documents that have the tag t, N is the number of documents having the topic T, and C is a constant, set to 0.99, for example. Save the set of tags, along with each tag's score, for the given topic where the scores exceed a threshold value and limit the number of tags saved by truncating the lowest scoring tags. Additionally, compute and record the prior probability of each distinct pair of tags occurring together in the same document.

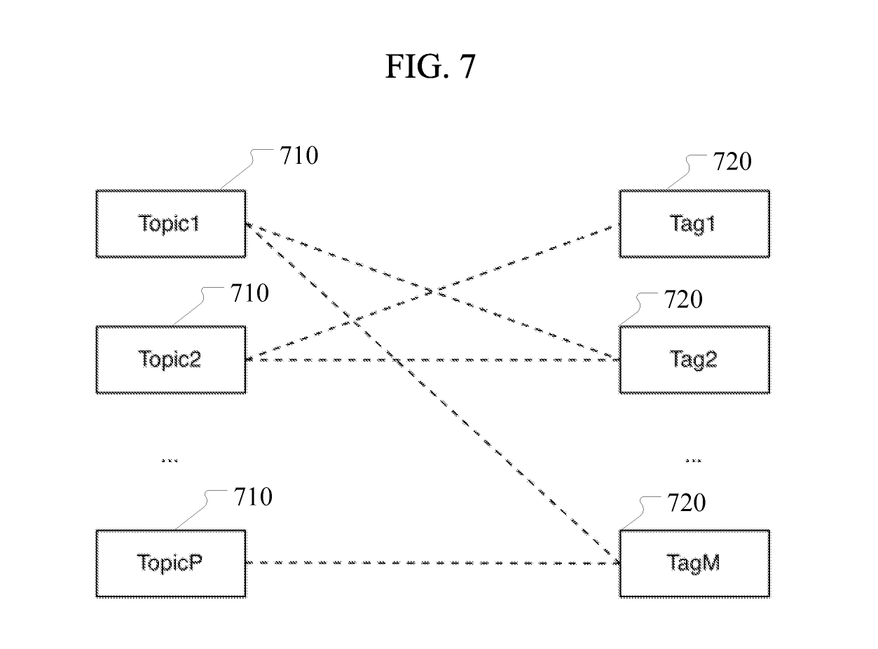

The steps described above will result in the topic-tag cloud illustrated in FIG. 7, which is essentially a set of tuples of the form (Tᵢ, tⱼ, Sᵢⱼ) along with the tag co-occurrence probabilities of the form (Tᵢ, tⱼ, tₖ, Sᵢⱼₖ).

Document Topic Expansion Using Topic-Tag Cloud

During document analysis, an additional phase is added following the conventional tag and topic assignment phases, using the following method. First, assemble a list of candidate topics. For each tag that was generated for the document, reverse look up all records from the topic-tag cloud. Aggregate the selected records by topic, allowing for fuzzy matching of variations in topic forms (e.g., “President Barack Obama”, “Barack Hussein Obama”, “Mr. Barack Obama” are variations of the topic “Barack Obama”) within the resulting set of topics. When considering which topic form to keep, examine the first phase of topic generation results in order to determine if, for example, the exact topic form exists therein.

Compute the final topic score for each aggregated topic as follows. Each topic-tag occurrence has a base score of:

S5_{T}_{ᵢ}ₜ_{ⱼ}_{d}=5_{T}_{ᵢ}ₜ_{ⱼ}*Sₜ_{ⱼ}_{d}

Examine which topics have more than one tag from the original document in their topic-tag cloud. This is another form of multiple-attestation and should result in the topic receiving an appropriate bonus. Create a co-occurrence sub-score using the co-occurrence information in the topic-tag cloud. If two tags co-occur frequently within documents that had a particular topic assignment, the topic deserves a higher score. This bonus mechanism enables, two tags, such as “horses” and “bayonets”, which may separately have low scores for the topic “Romney”, have a higher score when the tags are found together in the same document.

$${SC}_{tj} = \frac{{\sum }_{k} {N}_{jk} \cdot \frac{( {S}_{tj} + {S}_{tk} )}{2}}{{\sum }_{k} {N}_{k}}$$

where SCₜ_{ⱼ} is the co-occurring tag score, Nⱼₖ is the number of documents where both tags occur in the corpus, and Sₜ_{ⱼ} and Sₜ_{ₖ} are the average scores of the original and co-occurring tags, respectively, within the document subset, and Nₖ is the total number of documents in the corpus that contain the co-occurring tag for the topic being analyzed.

The score for tag tⱼ within topic Tᵢ as discovered by topic-tag cloud expansion is:

S_{T}_{ᵢ}ₜ_{ⱼ}_{d}=SB_{T}_{ᵢ}ₜ_{ⱼ}_{d}+(1−SB_{T}_{ᵢ}ₜ_{ⱼ}_{d})*\sqrt{SCₜ_{ⱼ}·M}

where M is a maximum bonus constant, set at 0.5 in one embodiment of the invention.

Combining the individual tag occurrences as follows, derives the final score for topic Tᵢ:

S_{T}_{ᵢ}=S_{T}_{_{i,n}} where S_{T}_{_{i,o}}=0,S_{T}_{_{i,j}}=S_{T}_{_{i,j-1}}+(1−S_{T}_{_{i,j-1}})·(S_{T}_{ᵢ}ₜ_{ⱼ}_{d}·Bⱼ)·C,j=1,2, . . . ,n

where n is the number of tag forms found for Tᵢ in the topic-tag cloud, and the base multiplier is:

Bⱼ=max(0.25, 0.45−((n−1)·0.050)

The result is a final set of second-order generated topics generated in virtue of the topic-tag cloud. Now these can be merged into the existing topic set that was previously generated for the document by the existing topic generation mechanism(s). Use fuzzy matching of topic forms when merging topics to avoid adding near-duplicate topics to the final, merged set of topics. If any topics that are being merged are an exact or fuzzy match to an existing topic, then apply a score modification to the existing topic score as follows: If the topic-tag cloud-generated topic score is high, then give the existing topic a distance-to-goal (DTG) score boost. If the topic-tag cloud-generated topic score is very low, then give the existing topic a penalty. The justification for modifying the score of a topic discovered in previous phase(s) is that the topic has essentially been doubly attested, once directly and again indirectly. This might seem redundant, but may make sense based on tag co-occurrence. The presence of other tags, which do not directly get promoted to a given topic, but are heavily correlated, may reinforce the applicability of the topic to the document. Conversely, if there are other tags present that are not part of the topic-tag cloud, then the topic might be somewhat tangential to the document. Using the score threshold, take the N top-scoring topics and add them to the final set of topics to be saved. Naturally, there are many other variations of this technique and many other applications.

### Exemplary Computing Environment

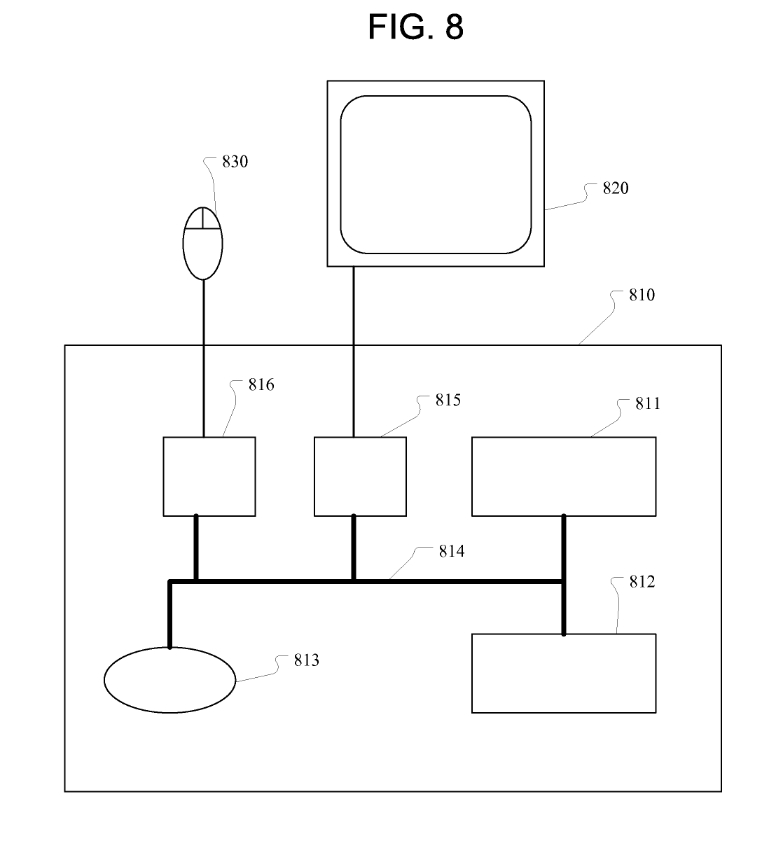

One or more of the above-described techniques may be implemented in or involve one or more computer systems. FIG. 8 illustrates a generalized example of a computing environment 800. The computing environment 800 is not intended to suggest any limitation as to scope of use or functionality of described embodiments.

With reference to FIG. 8, the computing environment 800 includes at least one processing unit 810 and memory 820. In FIG. 8, this most basic configuration 830 is included within a dashed line. The processing unit 810 executes computer-executable instructions and may be a real or a virtual processor. In a multi-processing system, multiple processing units execute computer-executable instructions to increase processing power. The memory 820 may be volatile memory (e.g., registers, cache, RAM), non-volatile memory (e.g., ROM, DDPROM, flash memory, etc.), or some combination of the two. In some embodiments, the memory 820 stores software 880 implementing described techniques.

A computing environment may have additional features. For example, the computing environment 800 includes storage 840, one or more input devices 850, one or more output devices 860, and one or more communication connections 870. An interconnection mechanism (not shown) such as a bus, controller, or network interconnects the components of the computing environment 800. Typically, operating system software (not shown) provides an operating environment for other software executing in the computing environment 800, and coordinates activities of the components of the computing environment 800.

The storage 840 may be removable or non-removable, and includes magnetic disks, magnetic tapes or cassettes, CD-ROMs, CD-RWs, DVDs, or any other medium which may be used to store information and which may be accessed within the computing environment 800. In some embodiments, the storage 840 stores instructions for the software 880.

The input device(s) 850 may be a touch input device such as a keyboard, mouse, pen, trackball, touch screen, or game controller, a voice input device, a scanning device, a digital camera, or another device that provides input to the computing environment 800. The output device(s) 860 may be a display, printer, speaker, or another device that provides output from the computing environment 800.

The communication connection(s) 870 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 800, computer-readable media include memory 820, storage 840, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A computer-implemented method executed by one or more computing devices for optimizing content targeting with optimal topics, the method comprising:
determining, by at least one of the one or more computing devices, one or more metadata characteristics associated with one or more topics of interest, wherein the one or more metadata characteristics include at least one primary metadata characteristic and at least one ancillary metadata characteristic associated with the at least one primary metadata characteristic;
determining, by at least one of the one or more computing devices, an inventory of at least one of the one or more metadata characteristics;
determining, by at least one of the one or more computing devices, one or more performance characteristics associated with at least one of the one or more metadata characteristics; and
determining, by at least one of the one or more computing devices, one or more optimal topics associated with at least one of the one or more metadata characteristics, wherein determining the one or more optimal topics is based at least in part on the inventory of at least one of the one or more metadata characteristics and the performance characteristics of at least one of the one or more metadata characteristics.

2. The method of claim 1, wherein the one or more metadata characteristics are associated with at least one of a topic, a keyword, a title, a named entity, and an abstract.

3. The method of claim 1, further comprising determining at least one additional metadata characteristic associated with at least additional topic determined through topic-tag cloud expansion.

4. The method of claim 1, wherein the at least one ancillary metadata characteristic is identified by the at least one primary metadata characteristic as being associated with the at least one primary metadata characteristic.

5. The method of claim 4, wherein the at least one primary metadata characteristic is identified by the at least one ancillary metadata characteristic as being associated with the at least one ancillary metadata characteristic.

6. The method of claim 1, wherein the one or more metadata characteristics further include at least one second-order metadata characteristic associated with the at least one ancillary metadata characteristic,
wherein the at least one second-order metadata characteristic is identified by the at least one ancillary metadata characteristic as being associated with the at least one ancillary metadata characteristic, and
wherein the at least one ancillary metadata characteristic is identified by the at least one second-order metadata characteristic as being associated with the at least one second-order metadata characteristic.

7. The method of claim 6, wherein at least one of the second-order metadata characteristics is associated with at least one second-order topic determined through topic-tag cloud expansion.

8. The method of claim 1, wherein the one or more metadata characteristics further include at least one third-order metadata characteristic related to the at least one second-order metadata characteristic,
wherein the at least one third-order metadata characteristic is identified by the at least one second-order metadata characteristic as being associated with the at least one second-order metadata characteristic, and
wherein the at least one second-order metadata characteristic is identified by the at least one third-order metadata characteristic as being associated with the at least one third-order metadata characteristic.

9. The method of claim 8, wherein at least one of the third-order metadata characteristics is associated with at least one third-order topic determined through topic-tag cloud expansion.

10. The method of claim 1, wherein determining the inventory of at least one of the one or more metadata characteristics is based at least in part on a predetermined inventory threshold.

11. The method of claim 1, wherein at least one of the one or more performance thresholds is associated with click-through-rate, mouse-over rate, and survey response rate.

12. The method of claim 1, wherein determining the one or more performance characteristics associated with at least one of the one or more metadata characteristics is based at least in part on at least one of current performance characteristics and historical performance characteristics associated with at least one of the one or more metadata characteristics.

13. An apparatus for optimizing content targeting with optimal topics, the apparatus comprising:
one or more processors; and
one or more memories operatively coupled to at least one of the one or more processors and having instructions stored thereon that, when executed by at least one of the one or more processors, cause at least one of the one or more processors to:
determine one or more metadata characteristics associated with one or more topics of interest, wherein the one or more metadata characteristics include at least one primary metadata characteristic and at least one ancillary metadata characteristic associated with the at least one primary metadata characteristic;
determine an inventory of at least one of the one or more metadata characteristics;
determine one or more performance characteristics associated with at least one of the one or more metadata characteristics; and
determine one or more optimal topics associated with at least one of the one or more metadata characteristics, wherein determining the one or more optimal topics is based at least in part on the inventory of at least one of the one or more metadata characteristics and the performance characteristics of at least one of the one or more metadata characteristics.

14. The apparatus of claim 13, wherein the one or more metadata characteristics are associated with at least one of a topic, a keyword, a title, a named entity, and an abstract.

15. The apparatus of claim 13, wherein at least one of the one or more memories has further instructions stored thereon that, when executed by at least one of the one or more processors, cause at least one of the one or more processors to determine at least one additional metadata characteristic associated with at least additional topic determined through topic-tag cloud expansion.

16. The apparatus of claim 13, wherein the at least one ancillary metadata characteristic is identified by the at least one primary metadata characteristic as being associated with the at least one primary metadata characteristic.

17. The apparatus of claim 16, wherein the at least one primary metadata characteristic is identified by the at least one ancillary metadata characteristic as being associated with the at least one ancillary metadata characteristic.

18. The apparatus of claim 13, wherein the one or more metadata characteristics further include at least one second-order metadata characteristic associated with the at least one ancillary metadata characteristic,
wherein the at least one second-order metadata characteristic is identified by the at least one ancillary metadata characteristic as being associated with the at least one ancillary metadata characteristic, and
wherein the at least one ancillary metadata characteristic is identified by the at least one second-order metadata characteristic as being associated with the at least one second-order metadata characteristic.

19. The apparatus of claim 18, wherein at least one of the second-order metadata characteristics is associated with at least one second-order topic determined through topic-tag cloud expansion.

20. The apparatus of claim 13, wherein the one or more metadata characteristics further include at least one third-order metadata characteristic related to the at least one second-order metadata characteristic,
wherein the at least one third-order metadata characteristic is identified by the at least one second-order metadata characteristic as being associated with the at least one second-order metadata characteristic, and
wherein the at least one second-order metadata characteristic is identified by the at least one third-order metadata characteristic as being associated with the at least one third-order metadata characteristic.

21. The apparatus of claim 20, wherein at least one of the third-order metadata characteristics is associated with at least one third-order topic determined through topic-tag cloud expansion.

22. The apparatus of claim 13, wherein determining the inventory of at least one of the one or more metadata characteristics is based at least in part on a predetermined inventory threshold.

23. The apparatus of claim 13, wherein at least one of the one or more performance thresholds is associated with click-through-rate, mouse-over rate, and survey response rate.

24. The apparatus of claim 13, wherein determining the one or more performance characteristics associated with at least one of the one or more metadata characteristics is based at least in part on at least one of current performance characteristics and historical performance characteristics associated with at least one of the one or more metadata characteristics.

25. At least one non-transitory computer-readable medium storing computer-readable instructions that, when executed by one or more computing devices, cause at least one of the one or more computing devices to:
determine one or more metadata characteristics associated with one or more topics of interest, wherein the one or more metadata characteristics include at least one primary metadata characteristic and at least one ancillary metadata characteristic associated with the at least one primary metadata characteristic;
determine an inventory of at least one of the one or more metadata characteristics;
determine one or more performance characteristics associated with at least one of the one or more metadata characteristics; and
determine one or more optimal topics associated with at least one of the one or more metadata characteristics, wherein determining the one or more optimal topics is based at least in part on the inventory of at least one of the one or more metadata characteristics and the performance characteristics of at least one of the one or more metadata characteristics.

26. The at least one non-transitory computer-readable medium of claim 25, wherein the one or more metadata characteristics are associated with at least one of a topic, a keyword, a title, a named entity, and an abstract.

27. The at least one non-transitory computer-readable medium of claim 25, further comprising instructions that, when executed by one or more computing devices, cause at least one of the one or more computing devices to determine at least one additional metadata characteristic associated with at least additional topic determined through topic-tag cloud expansion.

28. The at least one non-transitory computer-readable medium of claim 25, wherein the at least one ancillary metadata characteristic is identified by the at least one primary metadata characteristic as being associated with the at least one primary metadata characteristic.

29. The at least one non-transitory computer-readable medium of claim 28, wherein the at least one primary metadata characteristic is identified by the at least one ancillary metadata characteristic as being associated with the at least one ancillary metadata characteristic.

30. The at least one non-transitory computer-readable medium of claim 25, wherein the one or more metadata characteristics further include at least one second-order metadata characteristic associated with the at least one ancillary metadata characteristic,
wherein the at least one second-order metadata characteristic is identified by the at least one ancillary metadata characteristic as being associated with the at least one ancillary metadata characteristic, and
wherein the at least one ancillary metadata characteristic is identified by the at least one second-order metadata characteristic as being associated with the at least one second-order metadata characteristic.

31. The at least one non-transitory computer-readable medium of claim 30, wherein at least one of the second-order metadata characteristics is associated with at least one second-order topic determined through topic-tag cloud expansion.

32. The at least one non-transitory computer-readable medium of claim 25, wherein the one or more metadata characteristics further include at least one third-order metadata characteristic related to the at least one second-order metadata characteristic,
wherein the at least one third-order metadata characteristic is identified by the at least one second-order metadata characteristic as being associated with the at least one second-order metadata characteristic, and
wherein the at least one second-order metadata characteristic is identified by the at least one third-order metadata characteristic as being associated with the at least one third-order metadata characteristic.

33. The at least one non-transitory computer-readable medium of claim 32, wherein at least one of the third-order metadata characteristics is associated with at least one third-order topic determined through topic-tag cloud expansion.

34. The at least one non-transitory computer-readable medium of claim 25, wherein determining the inventory of at least one of the one or more metadata characteristics is based at least in part on a predetermined inventory threshold.

35. The at least one non-transitory computer-readable medium of claim 25, wherein at least one of the one or more performance thresholds is associated with click-through-rate, mouse-over rate, and survey response rate.

36. The at least one non-transitory computer-readable medium of claim 25, wherein determining the one or more performance characteristics associated with at least one of the one or more metadata characteristics is based at least in part on at least one of current performance characteristics and historical performance characteristics associated with at least one of the one or more metadata characteristics.
